(19) United States
(12) Patent Application Publication
(10) Pub. No.: US 2016/0065901 A1
(43) Pub. Date: Mar. 3, 2016

(54) THERMAL PATTERN MONITORING OF MACHINE

(71) Applicant: Caterpillar Inc., Peoria, IL (US)

(72) Inventors: Swapnil Padate, Peoria, IL (US); Michael Haptas, Peoria, IL (US); Katie J. Pierce, Rossville, IN (US); Philip B. Mann, Burr Ridge, IL (US)

(73) Assignee: Caterpillar Inc., Peoria, IL (US)

(21) Appl. No.: 14/934,172

(22) Filed: Nov. 6, 2015

(51) Int. Cl. H04N 7/18; B25J 15/00; G06K 9/62; G01J 5/08; G01M 99/00

(52) U.S. Cl. CPC H04N 7/18; G01J 5/08; G01M 99/002; G06K 9/6215; B25J 15/0019; G01J 2005/0077

(57) ABSTRACT

A method for monitoring thermal patterns of a machine includes identifying at least one location for positioning a robotic arm. The robotic arm is equipped with at least one of a visual camera and a thermal imaging camera adapted to capture a visual image and a thermal image of a portion of the machine, respectively. The method includes defining a plurality of segments of the portion by allocating a plurality of grids to the portion. Further, the portion of the machine is scanned by the robotic arm, based on the plurality of grids with the at least one of the visual camera and the thermal imaging camera. A component of the machine is detected, when the thermal patterns recorded for the component deviate from a predefined thermal pattern. The portion of the machine is then rescanned for determining changes in the thermal patterns as a function of time.

### TECHNICAL FIELD

The present disclosure relates to monitoring of thermal patterns of a machine, and more specifically to a thermal pattern monitoring apparatus and a method for monitoring the thermal patterns of the machine.

### BACKGROUND

Nowadays, analysis of thermal patterns of components of a machine using thermal imaging cameras has become a popular technique to determine a working condition of the components, and in turn, of the machine. The thermal imaging cameras are positioned in a close vicinity of the machine to be scanned while the machine is under operation. The thermal imaging cameras are positioned and controlled in such a manner that the component of the machine is appropriately monitored.

However, operations of the thermal imaging cameras are controlled manually. Due to the manual controlling, the accuracy of the images captured for analyzing the thermal patterns is compromised. Further, a repeatability of the thermal imaging cameras, i.e., when the thermal imaging cameras have to travel along a predefined path repeatedly, is poor. In addition, the thermal imaging cameras may not appropriately capture difficult-to-reach components of the machine. As a result, the thermal images for the difficult-to-reach components may not be suitable for accurately analyzing the thermal patterns of such components. Moreover, since the operator has to be present in a close vicinity of the machine for manually controlling the machine, the operator may have to wear heavy and complicated protective suits to be able to withstand the environment around the machine. Such protective suits are expensive and cause discomfort to the operator. This would hamper the efficiency and accuracy of the operator, and in turn, of the operations of the thermal imaging cameras being controlled by the operator.

US Application Number 2014/0263752 A1, hereinafter referred to as '752 application, describes an automated sprayer assembly. A thermal imaging device can be associated with the sprayer assembly to facilitate thermal imaging of the die mold. The thermal imaging device can be mounted on a robotic arm that facilitates movement of the thermal imaging device into the die mold once the casting has been removed. Further, an automated control system can include a robotic arm that is coupled with the sprayer assembly and facilitates movement of the sprayer head relative to a die mold. However, the '752 application does not disclose the application of robotic arm with the thermal imaging device for monitoring thermal patterns of the machine. Further, the '752 application offers a complicated and expensive structure with more number of components.

### SUMMARY OF THE DISCLOSURE

In one aspect of the present disclosure, a method for monitoring thermal patterns of a machine is disclosed. The method includes identifying at least one location for positioning a robotic arm. The robotic arm is equipped with at least one of a visual camera and a thermal imaging camera adapted to capture a visual image and a thermal image of a portion of the machine, respectively. The at least one location is identified based on the portion to be monitored and an operating range of the robotic arm. The method includes defining a plurality of segments of the portion by allocating a plurality of grids to the portion. The method further includes scanning, by the robotic arm, the portion of the machine based on the plurality of grids with the at least one of the visual camera and the thermal imaging camera. Upon scanning of the portion, the method includes detecting a component of the machine, where the component is from the scanned portion, when the thermal patterns recorded for the component deviate from a predefined thermal pattern set for the component. The method further includes storing data pertaining to the recorded thermal patterns of the component. The method further includes rescanning the portion of the machine with the at least one of the visual camera and the thermal imaging camera for determining changes in the thermal patterns as a function of time.

Other features and aspects of this disclosure will be apparent from the following description and the accompanying drawings.

### BRIEF DESCRIPTION OF THE DRAWINGS

FIG. 1 is an isometric view of a machine and a thermal pattern monitoring apparatus positioned to scan the machine for thermal patterns, according to concepts of the present disclosure;

FIG. 2 is the thermal pattern monitoring apparatus for scanning the machine, according to concepts of the present disclosure;

FIG. 3 is a flow chart depicting a method for monitoring thermal patterns of the machine, according to concepts of the present disclosure; and

FIG. 4 is a diagrammatic view of the machine defined by a plurality of segments by allocating a plurality of grids to the machine by the thermal pattern monitoring apparatus, according to concepts of the present disclosure.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. Any reference to elements in the singular is also to be construed to relate to the plural and vice-versa without limiting the scope of the disclosure to the exact number or type of such elements unless set forth explicitly.

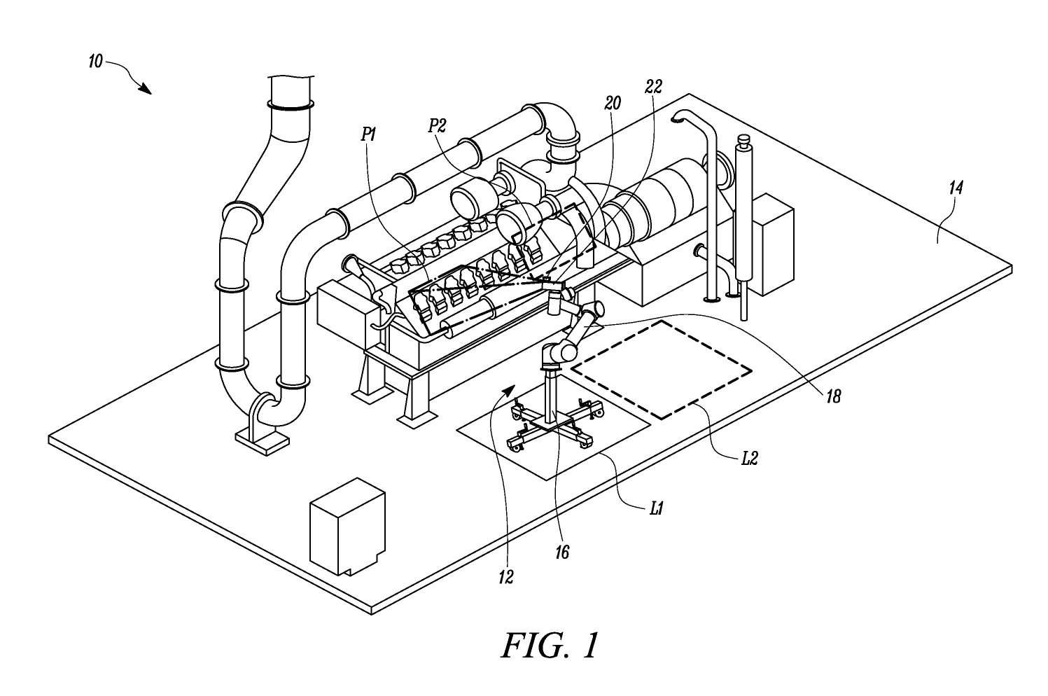

As shown in FIG. 1, a machine 10 may be an engine located in a test cell for testing and inspection. The machine 10 is in an operational mode, and is positioned on an inspection platform 14 in the test cell. For scanning the machine 10 for thermal patterns, a thermal pattern monitoring apparatus 12 is positioned at a location near the machine 10 for capturing a single specific portion of the machine 10 at a time. Initially, the thermal pattern monitoring apparatus 12 is positioned at a location L1 for scanning a portion P1 of the machine 10. Once the portion P1 is scanned, the thermal pattern monitoring apparatus 12 is shifted to a location L2 for scanning a portion P2 of the machine 10. The position of the thermal pattern monitoring apparatus 12 is shifted around the machine 10 till the entire machine 10 is scanned for the thermal patterns.

For scanning the entire machine 10 at the same time, multiple thermal pattern monitoring apparatuses 12 may be positioned at multiple locations so as to capture multiple portions of the machine 10. The number of thermal pattern monitoring apparatuses 12 to be employed and the positioning of the thermal pattern monitoring apparatuses 12 depend on factors, such as components to be scanned, a motion range of the thermal pattern monitoring apparatus 12, and dimensional characteristics of the machine 10.

The thermal pattern monitoring apparatus 12 includes a mounting stand 16 to be fixed at the location, a robotic arm 18 disposed on the mounting stand 16, a visual camera 20 and a thermal imaging camera 22 mounted on the robotic arm 18.

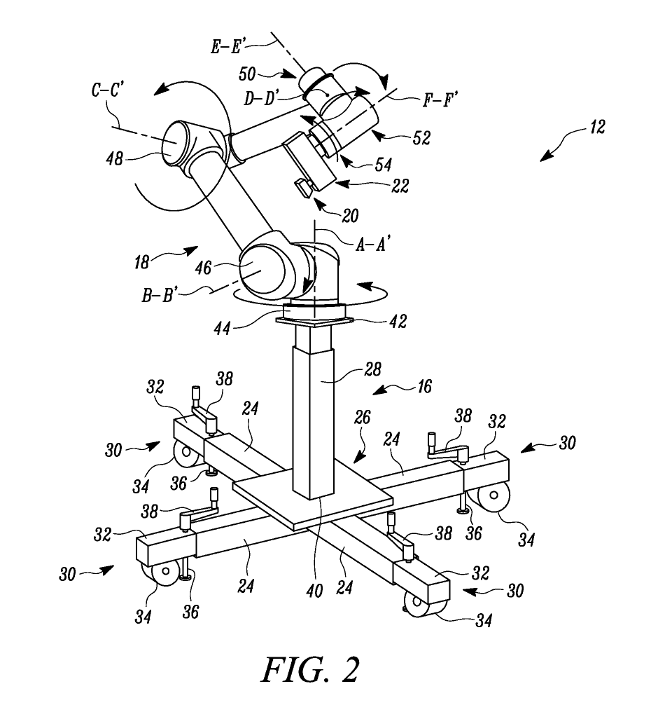

As shown in FIG. 2, the thermal pattern monitoring apparatus 12 includes the mounting stand 16 for supporting the robotic arm 18. The mounting stand 16 includes a pair of horizontal arms 24 connected to each other through a fixed connection 26, and a vertical arm 28 connected to the pair of horizontal arms 24 at the fixed connection 26. Both the horizontal arms 24 are connected to each other at about their respective center points. Each horizontal arm 24 includes a lockable wheel assembly 30 disposed on opposite ends 32 for supporting the mounting stand 16 on the inspection platform 14. The lockable wheel assembly 30 includes a wheel 34 for moving the mounting stand 16 from one position to another position, a locking insert 36 for restricting the movement of the wheel 34, and a rotatable lever 38 for actuating the locking insert 36. Further, the vertical arm 28 includes a first end 40 connected to the fixed connection 26 and a second end 42 for being connected to the robotic arm 18. The mounting stand 16 is extendable and the height is changed by moving the vertical arm 28 for providing a desired elevation to the robotic arm 18 for scanning the machine 10.

The robotic arm 18 includes a stationary base 44, a shoulder 46 mounted on the base 44, an elbow 48 connected to the shoulder 46, a first wrist 50 connected to the elbow 48, a second wrist 52 connected to the first wrist 50, and a third wrist 54 connected to the second wrist 52. The robotic arm 18 is mounted on the mounting stand 16 through the base 44.

The robotic arm 18 is a 6-axis robotic arm 18 providing a movement of 6 degrees-of-freedom. The robotic arm 18 rotates about the base 44 along a first axis of rotation AA′. The first axis of rotation AA′ is a vertical axis. The robotic arm 18 rotates about the shoulder 46, the elbow 48, and the first wrist 50 along a second axis of rotation BB′, a third axis of rotation CC′, and a fourth axis of rotation DD′, respectively. The second axis of rotation BB′, the third axis of rotation CC′, and the fourth axis of rotation DD′ are horizontal axes. The robotic arm 18 further rotates about the second wrist 52 and the third wrist 54 along a fifth axis of rotation EE′ and a sixth axis of rotation FF′, respectively.

Further, the visual camera 20 and the thermal imaging camera 22 are connected to the robotic arm 18 through the third wrist 54. The visual camera 20 and the thermal imaging camera 22 are connected so as to avoid any possibility of interference of field of views therebetween. The visual camera 20 is a standard image capturing camera for capturing a real life image of the component or the portion to be scanned.

The thermal imaging camera 22 is a camera that is equipped to capture images of the portion indicating the thermal patterns of the components in the scanned portion. During operation, a lens of the thermal imaging camera 22 focuses a thermal radiation emitted by a component of the machine 10 onto a sensor. The sensor detects the thermal radiation, and then converts the thermal radiation into thermal image data. A processor processes the thermal image data to generate a thermal image of the component. The thermal image is provided to an operator through a display device.

In one example, the thermal pattern monitoring apparatus 12 may include an interactive display device (not shown) for communicating with the operator. The interactive display device may further be equipped with a touch-screen functionality so that the operator may provide appropriate instructions for operating the thermal pattern monitoring apparatus 12 to the interactive display device. In another example, the operator may use other input devices, such as a keyboard, a speech recognition device, and a mouse for providing the instructions to the thermal pattern monitoring apparatus 12. In one example, the functionalities of the display screen of the thermal imaging camera 22 may be provided to the interactive display screen. Further, the interactive display device may be positioned inside as well as outside the test cell so that the thermal pattern monitoring apparatus 12 may be operated from inside as well as from outside the test cell, respectively.

In one example, the engine may be replaced with any machine, without departing from the scope of the present disclosure. Such machines may include, but are not limited to, machines associated with any industry, such as mining, construction, farming, aviation, automotive, and transportation. For example, the thermal pattern monitoring apparatus 12 may be employed to scan turbines, compressors, and Heating Ventilation and Air Conditioning (HVAC) systems for thermal patterns.

In one example, the test cell may include cameras, for example, Closed Circuit Television (CCTV) cameras, mounted on walls of the test cell so as to supervise the operation of the thermal pattern monitoring apparatus 12. The cameras may be utilized to ensure that the movement of the robotic arm 18 is correct and cannot cause harm to the robotic arm 18 due to a collision with the machine 10 or any other component in the test lab.

In one example, the thermal pattern monitoring apparatus 12 is mounted on an overhead conveyor system (not shown). In such an example, the overhead conveyor system may move the thermal pattern monitoring apparatus 12 around the machine 10 for scanning the machine 10 for thermal patterns.

### INDUSTRIAL APPLICABILITY

The present disclosure relates to the thermal pattern monitoring apparatus 12 for monitoring thermal patterns of the machine 10. The thermal pattern monitoring apparatus 12 includes the mounting stand 16, the robotic arm 18, the visual camera 20, and the thermal imaging camera 22. The thermal pattern monitoring apparatus 12 is positioned around the machine 10 to be scanned. The thermal pattern monitoring apparatus 12 has applications in a wide range of industries where a thermal pattern analysis is performed.

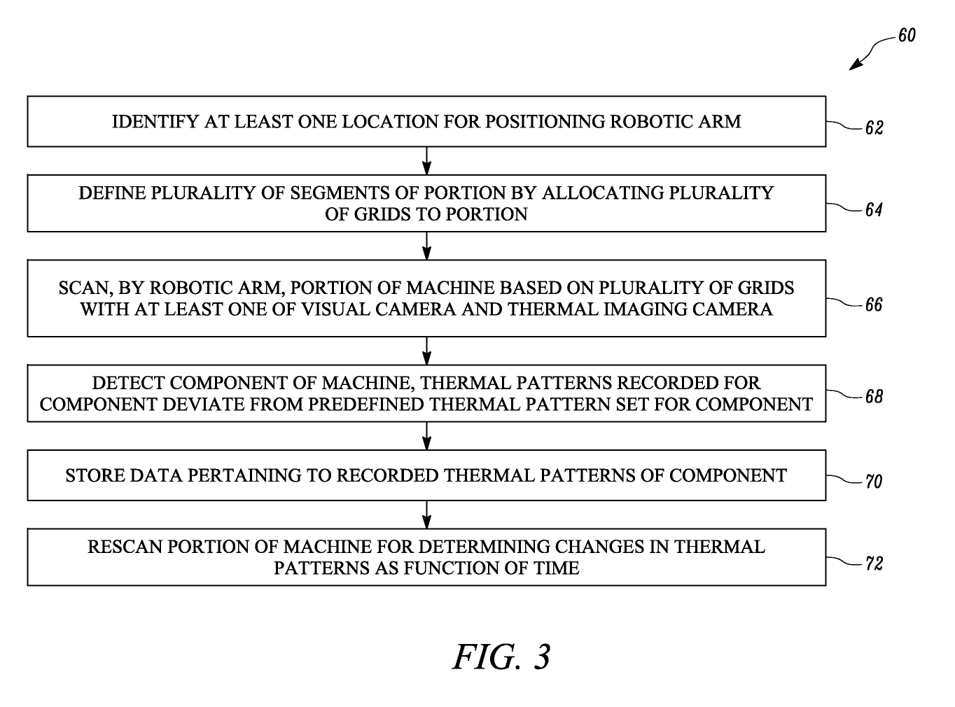

Referring to FIG. 3, at step 62, the method 60 includes identifying at least one location for positioning the robotic arm 18 and in turn the thermal pattern monitoring apparatus 12 for scanning the machine 10. The location of the thermal pattern monitoring apparatus 12 is identified based on the portion of the machine 10 to be monitored and an operating range of the robotic arm 18. The operating range of the robotic arm 18 is indicative of a field of reach of the robotic arm 18. The thermal pattern monitoring apparatus 12 has to be located so as to appropriately capture the portion of the machine 10 for thermal patterns.

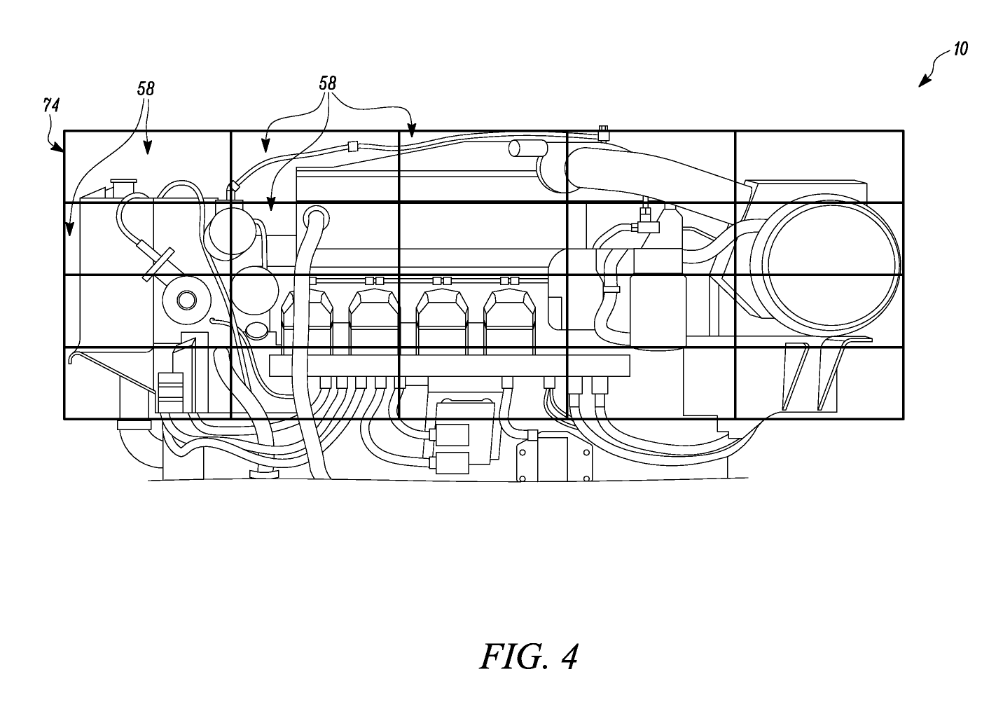

At step 64, the method 60 includes defining a plurality of segments 58 of the portion of the machine 10. The plurality of segments 58 may be defined by the thermal pattern monitoring apparatus 12 by allocating a plurality of grids 74 to the portion. FIG. 4 shows the machine 10 defined by the plurality of segments 58 by allocating the plurality of grids 74 by the thermal pattern monitoring apparatus 12. In the present disclosure, the machine 10 is defined by 20 grids 74 and therefore, 20 corresponding segments 58 of the machine 10. As shown, the grid size is a 5×4 matrix.

Referring back to FIG. 3, at step 66, the method 60 includes scanning the portion of the machine 10 by the robotic arm 18 of the thermal pattern monitoring apparatus 12. The thermal pattern monitoring apparatus 12 scans the portion based on the plurality of grids 74. The portion is scanned by using at least one of the visual camera 20 and the thermal imaging camera 22. The thermal imaging camera 22 captures a thermal image of the portion whereas the visual camera 20 captures a real-life image of the portion. The thermal pattern monitoring apparatus 12 uses the thermal image as well as the real-life image for further analysis.

At step 68, the method 60 includes detecting a component, from the portion, that shows abnormality in terms of the thermal patterns emitted by the component. The component is detected based on a deviation of the thermal patterns from a predefined thermal pattern set for the component.

At step 70, the method 60 includes storing the data pertaining to the thermal patterns of the component. The data includes, but is not limited to, thermal patterns of components, temperature of the components, and predefined thermal patterns for the components.

At step 72, the method 60 includes re-scanning the portion of the machine 10 with the at least one of the visual camera 20 and the thermal imaging camera 22. The portion is rescanned for capturing the thermal patterns of the components at different time instances. Based on the thermal images obtained for the components at different time instances, changes in the thermal patterns of the components as a function of time is determined.

With the present disclosure, the thermal pattern monitoring apparatus 12 and the method 60 offer a simple and easy technique for monitoring thermal patterns of the machine 10. The thermal pattern monitoring apparatus 12 is user-friendly that is easy to operate and does not require a highly skilled operator. Further, the 6-axis rotation structure of the robotic arm 18 provides the thermal pattern monitoring apparatus 12 with flexibility to access difficult-to-reach components of the machine 10. Such structure of the robotic arm 18 assists in tracing a wide range of profile paths for scanning the machine 10. Also, the installation and uninstallation of the thermal pattern monitoring apparatus 12 is a time-effective and convenient process. Furthermore, the repeatability of the robotic arm 18 for performing the same movement multiple times is accurate. Therefore, the thermal pattern monitoring apparatus 12 is a consistent system for repeating similar movements. Such merits of the thermal pattern monitoring apparatus 12 lead to an accurate and effective monitoring of thermal patterns of the machine 10.

Moreover, the method 60 offers a convenient approach to monitor and analyze thermal patterns of the machine 10 in an effective manner. Since the machine 10 is defined by the plurality of segments 58 of the portion by allocating the plurality of grids 74, the focus area for the thermal pattern monitoring apparatus 12 to scan is reduced which in turn result in an increase in the accuracy of the monitoring of the thermal patterns. Therefore, the present disclosure offers the thermal pattern monitoring apparatus 12 and the method 60 that is simple, effective, easy to use, economical, and time-saving.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for monitoring thermal patterns of a machine, the method comprising:
identifying at least one location for positioning a robotic arm, the robotic arm being equipped with at least one of a visual camera and a thermal imaging camera adapted to capture a visual image and a thermal image of a portion of the machine, respectively, wherein the at least one location is identified based on the portion to be monitored and an operating range of the robotic arm;
defining a plurality of segments of the portion by allocating a plurality of grids to the portion;
scanning, by the robotic arm, the portion of the machine based on the plurality of grids with the at least one of the visual camera and the thermal imaging camera;
detecting a component of the machine, the component being from the portion, wherein the thermal patterns recorded for the component deviate from a predefined thermal pattern set for the component;
storing data pertaining to the recorded thermal patterns of the component; and
rescanning the portion of the machine with the at least one of the visual camera and the thermal imaging camera for determining changes in the thermal patterns as a function of time.
